(19) United States
(12) Patent Application Publication
(10) Pub. No.: US 2026/0273903 A1
(43) Pub. Date: Sep. 17, 2026

(54) A PACKAGING LAMINATE

(71) Applicant: Hariharan Krishnan Nair, Mumbai (IN)

(72) Inventors: Hariharan Krishnan Nair, Mumbai (IN); Gurunath Pozhal Vengu, Bangalore (IN)

(21) Appl. No.: 19/167,767

(22) PCT Filed: Mar. 22, 2024
(86) PCT No.: PCT/IN2024/050298

§ 371 Date: Sep. 22, 2025

(30) Foreign Application Priority Data
Mar. 23, 2023 (IN) 202321020589

(51) Int. Cl. B32B 27/08; B32B 7/12; B32B 27/30; B32B 27/32; B32B 27/34

(52) U.S. Cl. CPC B32B 27/08; B32B 7/12; B32B 27/306; B32B 27/32; B32B 27/34; B32B 2250/03; B32B 2250/24; B32B 2250/40; B32B 2307/7244; B32B 2307/7376; B32B 2553/00

(57) ABSTRACT

The present disclosure provides a packaging laminate comprising (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part; the second part is in contact with the exterior part on both sides; and the barrier component of at least one of the top second part and the bottom second part comprises a layer of melt processable polyvinyl alcohol. Further, the present disclosure provides a process for preparing the packaging laminate as disclosed herein.

### FIELD OF INVENTION

The present disclosure in general relates to a field of packaging. Particularly, the present disclosure relates to a packaging laminate, process of preparation, and article thereof.

### BACKGROUND OF THE INVENTION

Among the various strategies to develop a recyclable polymeric material with enhanced barrier properties, polyvinyl alcohol is prominent barrier component used in laminates. The barrier properties include prevention against packaged product seeping, gaseous penetration through the wall, contamination of the product and reaction with the packaging material. Although polyvinyl alcohol (PVOH) has significant barrier properties, there are limitations towards the processability of PVOH in packaging materials. This is because of the melting of the irregular crystals of PVOH and non-melting of regular crystals of PVOH leading to the effect called particle flow, by which the PVOH crystals become difficult to be melted to a homogenous polymeric blend in a conventional thermoplastic processing equipment such as an extruder. The commonly adopted solution to this issue is that the temperature of PVOH was set to an optimum point where the decomposition is prevented. For PVOH, the pyrolysis temperature is reached before the melting point, hence it has not been possible to use normal melt extrusion process. Though there were few research attempts to improve the thermal stability, till now, there has not been widespread adaptation or availability of melt process-able form of PVOH. Mostly PVOH is used as an aqueous coating. However, this method still faces post-manufacturing issues such as peeling off of multi-layered laminates. Further, the requirement of blown film processable PVOH is desirable and is an unmet need.

### SUMMARY INVENTION

In an aspect of the present disclosure, there is provided a packaging laminate comprising: a. an exterior part of at least one alkylene polymer; b. a second part comprising a top second part and a bottom second part having at least one barrier component; and c. a center part of at least one alkylene polymer, wherein the center part is disposed between the top second part and the bottom second part; the second part is in contact with the exterior part on both sides; the barrier component of at least one of the top second part and the bottom second part comprises a layer of melt processable polyvinyl alcohol; and each of the layer of melt processable polyvinyl alcohol has a thickness in a range of 1 to 15 microns.

In another aspect of the present disclosure, there is provided a process of preparing the packaging laminate as disclosed herein, wherein the laminate is prepared by a process selected from blown film process, cast film process, and extrusion lamination and/or adhesive lamination of blown or cast films.

In still another aspect of the present disclosure, there is provided an article comprising the packaging laminate as disclosed herein.

In yet another aspect of the present disclosure, there is provided a use of the packaging laminate as disclosed herein.

These and other features, aspects and advantages of the present subject matter will be better understood with reference to the following disclosure. This summary is provided to introduce a selection of concepts in a simplified form. This summary is not intended to identify key features or essential features of the claimed subject matter, nor is it intended to be used to limit the scope of the claimed subject matter.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified.

The term “at least one” is used to mean one or more and thus includes individual components as well as mixtures/combinations.

The term “packaging laminate” refers to a mono- or multi-layered laminate material used for packaging products to increase their shelf-life and give a good aesthetic feel.

The term “barrier component” refers to a component which has barrier properties. The term “barrier properties” refers to the properties of a material to prevent product seeping through its wall, resist gaseous penetration from the environment and product contamination with low reactivity and high flexibility.

The term “at least one alkylene polymer” refers to the polymeric material obtained from the alkylene type monomers. In an aspect of the present disclosure, the laminate disclosed herein comprises an exterior part of at least one alkylene polymer. In another aspect of the present disclosure, the at least one alkylene polymer is a monolayer or a multilayer of an alkylene polymer having density in a range of 0.833 g/cm³ to 0.99 g/cm³.

The term “polyvinyl alcohol” refers to the polymeric material obtained from the vinyl alcohol monomers, which has enhanced barrier properties. In an aspect of the present disclosure, the barrier component comprises a layer of melt processable polyvinyl alcohol.

The term “extrusion” refers to the process off expulsion of a substance through a die to obtain the material in desired cross-sections. In an aspect of the present disclosure, a layer of polyvinyl alcohol is obtained by extrusion of a solid polyvinyl alcohol granules or pellets.

The term “solid polyvinyl alcohol” refers to the melt-processable polyvinyl alcohol material in solid granular or pellet form.

The term “resin” refers to materials that are useful in adjoining different layers or parts. For the purpose of the present disclosure, resins are used to adjoin the parts of the laminate. The resin include but not limited to laminating resin, tie resin, adhesive resin and promoter resin. The resin is selected from low-density polyethylene, linear low-density polyethylene, medium-density polyethylene, high-density polyethylene, maleated polyethylene, anhydride grafted ethylene/1-butene copolymer, anhydride grafted ethylene/1-hexene copolymer, propylene ethylene copolymer, ethylene vinyl acetate copolymer, ethylene methyl acrylate copolymer, anhydride grafted ethylene/1-octene copolymer, polyurethane, polyethylene imine or combinations thereof.

The term “adhesive resin” refers to the resin material used as a fastening component to combine the different layers of multi-layered packaging laminate. In an aspect of the present disclosure, the adhesive resin is polyurethane.

The term “promoter resin” refers to the resin material used to initiate or promote the tight bonding/fastening of the multiple layers in the packaging laminate. In an aspect of the present disclosure, the promoter resin is polyethylene imine.

The term “oxygen transmission rate (OTR)” refers to the steady state rate at which oxygen permeates through a packaging laminate at specified conditions of temperature and relative humidity. In an aspect of the present disclosure, the laminate has an oxygen transmission rate (OTR) equal to or less than 0.05 cm³/m²/1 day/1 atm, at a temperature in the range of 22° C.-25° C. at a relative humidity of 0% RH, ASTM D 3985-05.

The term “blown film process” refers to the process of obtaining thin laminate of a material which comprises the steps of extrusion of bulk material, expansion and blowing using internal pressure.

The term “cast film process” refers to the process of obtaining thin laminate of a material which comprises the steps of extrusion of bulk material through a slit onto cool, polished rollers, expansion of the material using the rollers with quenching from one side and drawing the film at appropriate speed for desired draw ratio and film thickness.

The term “extrusion lamination” refers to the process of obtaining thin laminate of a material which comprises joining two or more packaging films by extrusion of a resin in a film shape placed in between the two packaging laminates.

The term “adhesive lamination” refers to the process of obtaining laminate of a material which comprises joining two or more packaging films using an adhesive resin.

The term “lamitube” are tubular laminate materials used to package viscous semi-liquid products such as creams, gels, pastes etc.

The term “shoulder barrier liner” refers to the barrier material used to line the entire shoulder part of a lamitube in order to improve the structural and barrier properties of the dented region.

The term “inner barrier liner” refers to the barrier material used to line the shoulder part of the lamitube but not covering its dispensing nozzle to improve the barrier properties of entire lamitube.

The term “pouch” refers to the enclosed bag-like container which can be used for the package of materials for separate consumer-usage wherein the pouch may or may not comprise a sealable edge to air-tight the product to be packed.

As discussed in the background, irregular melting of PVOH leading to particle flow, results in decomposition of PVOH at certain sites and non-uniform melting in other sites. This difficulty in achieving a homogenous polymeric blend from PVOH crystals hence required a solution. When the temperature of PVOH was set to an optimum point so as to achieve homogenous polymeric blends, the decomposition is prevented but still has to face post-manufacturing issues such as peeling off of multi-layered laminates thus limiting its industrial applicability.

In accordance with the above-mentioned problems, the present disclosure provides inclusion of melt processable solid PVOH granules for the manufacture of multi-layered packaging laminate. The PVOH granules being thermally more stable and can withstand melt processing. The granules can be melt-processed (extruded) without decomposition because the equipment only has to melt the pellets and generate sufficient pressure to obtain the homogenous polymeric melt. Therefore, in the present disclosure, there is provided a packing laminate and/or an article comprising: (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part; the second part is in contact with the exterior part on both sides; and the barrier component of at least one of the top second part and the bottom second part comprises a layer of melt processable polyvinyl alcohol obtained from solid poly vinyl alcohol granules.

Accordingly, the present disclosure provides a packaging laminate comprising: (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part; the second part is in contact with the exterior part on both sides; and the barrier component of at least one of the top second part and the bottom second part comprises a layer of melt-processable polyvinyl alcohol.

In an embodiment of the present disclosure there is provided a packaging laminate comprising: (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part; the second part is in contact with the exterior part on both sides; the barrier component of at least one of the top second part and the bottom second part comprises a layer of melt-processable polyvinyl alcohol, and each of the layer of melt processable polyvinyl alcohol has a thickness in a range of 1 to 15 microns.

In an embodiment of the present disclosure, there is provided a packaging laminate having barrier properties, the laminate comprising: (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part; the second part is in contact with the exterior part on both sides; and the barrier component of at least one of the top second part and the bottom second part comprises a layer of polyvinyl alcohol, each of the layer having thickness in a range of 1 to 15 microns obtained from extrusion of solid polyvinyl alcohol granules.

In an embodiment of the present disclosure, there is provided a packaging laminate as disclosed herein, wherein the barrier component comprises one or more layers of ethylene vinyl alcohol, nylon, or combinations thereof.

In an embodiment of the present disclosure, there is provided a packaging laminate as disclosed herein, wherein the center part of at least one alkylene polymer is disposed between the top second part and the bottom second part on both sides. In another embodiment of the present disclosure, the second part is in contact with the exterior part on both sides. In one another embodiment of the present disclosure, the top second part is in contact with the exterior part on one side of the laminate. In another embodiment of the present disclosure, the bottom second part is in contact with the exterior part on other side of the laminate.

In an embodiment of the present disclosure, there is provided a packaging laminate as disclosed herein, wherein the barrier component comprises one or more layers of ethylene vinyl alcohol, nylon, or combinations thereof. In another embodiment of the present disclosure, the barrier component of at least one of the top second part and the bottom second part comprises a layer of polyvinyl alcohol. In another embodiment of the present disclosure, the top second part and the bottom second part are both one or more layers of polyvinyl alcohol. In another embodiment of the present disclosure, the top second part comprises one or more layers of polyvinyl alcohol and the bottom second part comprises a barrier component selected from one or more layers of polyvinyl alcohol, ethylene vinyl alcohol, nylon, or combinations thereof. In another embodiment of the present disclosure, the top second part comprises a barrier component selected from one or more layers of polyvinyl alcohol, ethylene vinyl alcohol, nylon, or combinations thereof and the bottom second part comprises one or more layers of polyvinyl alcohol. In yet another embodiment of the present disclosure, the top second part comprises one or more layers of poly vinyl alcohol and a bottom second part comprises one or more layers of ethylene vinyl alcohol. In still another embodiment, the top second part comprises one or more layers of ethylene vinyl alcohol and the bottom second part comprises one or more layers of poly vinyl alcohol.

In an embodiment of the present disclosure, there is provided a packaging laminate comprising: (a) an exterior part of at least one alkylene polymer; (b) a second part comprising a top second part and a bottom second part having at least one barrier component; and (c) a center part of at least one alkylene polymer, wherein the center part is disposed between the top second part and the bottom second part on both sides; the second part is in contact with the exterior part on both sides; the barrier component of at least one of the top second part and the bottom second part is polyvinyl alcohol on both sides and alkylene polymer is a monolayer of an alkylene polymer having density in a range of 0.833 g/cm³-0.99 g/cm³. In another embodiment, the alkylene polymer is a multilayer of an alkylene polymer having density in a range of 0.833 g/cm³-0.99 g/cm³.

In an embodiment of the present disclosure, there is provided a packaging laminate comprising: (a) an exterior part of at least one alkylene polymer; (b) a second part comprising a top second part and a bottom second part having at least one barrier component; and (c) a center part of at least one alkylene polymer, wherein the center part is disposed between a top second part and a bottom second part on both sides; the barrier component of at least one of the top second part and the bottom second part is polyvinyl alcohol. In another embodiment, the top second part is ethylene vinyl alcohol, and the bottom second part is poly vinyl alcohol. In yet another embodiment of the present disclosure, the top second part is polyvinyl alcohol and the bottom second part is ethylene vinyl alcohol.

In an embodiment of the present disclosure, there is provided a packaging laminate as disclosed herein, wherein the exterior part is at least one alkylene polymer is a monolayer or a multilayer of an alkylene polymer having density in a range of 0.833 g/cm³-0.99 g/cm³. In another embodiment, the alkylene polymer is a monolayer or a multilayer of an alkylene polymer having density preferably in a range of 0.910 g/cm³ to 0.980 g/cm³. In still another embodiment, the alkylene polymer is a monolayer or a multilayer of an alkylene polymer having density more preferably in the range of 0.935 g/cm³ to 0.970 g/cm³.

In an embodiment of the present disclosure, there is provided a packaging laminate as disclosed herein, wherein the exterior part has a thickness in a range of 3 μm to 200 μm. In another embodiment of the present disclosure, the exterior part has a thickness in a range of 20 to 180 μm.

In an embodiment of the present disclosure, there is provided a packaging laminate as disclosed herein, wherein the center part has a thickness in a range of 1 μm to 250 μm. In another embodiment of the present disclosure, the center part has a thickness in a range of 20 to 200 μm.

In an embodiment of the present disclosure, there is provided a packaging laminate as disclosed herein, wherein the second part has a thickness in a range of 2 μm to 150 μm. In another embodiment of the present disclosure, the second part has a thickness in a range of 2 to 100 μm.

In an embodiment of the present disclosure, there is provided a packaging laminate as disclosed herein, wherein the laminate has a thickness in a range of 6 μm to 400 μm. In another embodiment of the present disclosure, the laminate has a thickness in a range of 45 to 350 μm.

In an embodiment of the present disclosure, there is provided a packaging laminate as disclosed herein, wherein the exterior part, the second part, and the center part are joined together by one or more layers of a resin selected from a group consisting of a laminating resin, tie resin, an adhesive resin, and a promoter resin.

In an embodiment of the present disclosure, there is provided a packaging laminate as disclosed herein, wherein the one or more layers of the resin has a thickness in a range of 2 μm to 70 μm. In another embodiment, the one or more layers of the resin has a thickness preferably in a range of 5 to 50 μm. In still another embodiment, the one or more layers of the resin has a thickness more preferably in a range of 15 to 35 μm.

In an embodiment of the present disclosure, there is provided a packaging laminate as disclosed herein, wherein the exterior part, the second part, and the center part are joined together by one or more layers of a resin selected from the group consisting of low density polyethylene, linear low density polyethylene, medium density polyethylene, high density polyethylene, maleated polyethylene, anhydride grafted ethylene/1-butene copolymer, anhydride grafted (ethylene/1-hexene copolymer, propylene ethylene copolymer), ethylene vinyl acetate copolymer, ethylene methyl acrylate copolymer, anhydride grafted ethylene/1-octene copolymer, and combinations thereof; an adhesive resin as polyurethane; the promoter resin as polyethylene imine or combinations thereof.

In an embodiment of the present disclosure, there is provided a packaging laminate comprising: (a) an exterior part of at least one alkylene polymer; (b) a second part comprising a top second part and a bottom second part having at least one barrier component; and (c) a center part of at least one alkylene polymer disposed between a top second part and a bottom second part on both sides, wherein the exterior parts, the second parts, and the center part are joined together by one or more layers of a resin selected from a group consisting of a tie resin, an adhesive resin, and a promoter resin.

In an embodiment of the present disclosure, there is provided a packaging laminate comprising: (a) an exterior part of at least one alkylene polymer; (b) a second part comprising a top second part and a bottom second part having at least one barrier component; and (c) a center part of at least one alkylene polymer, wherein the at least one alkylene polymer is a monolayer or a multilayer of an alkylene polymer having density in a range of 0.833 g/cm³-0.99 g/cm³.

In an embodiment of the present disclosure, there is provided a packaging laminate comprising: (a) an exterior part of at least one alkylene polymer; (b) a second part comprising a top second part and a bottom second part having at least one barrier component; and (c) a center part of at least one alkylene polymer disposed between a top second part and a bottom second part on both sides, wherein the exterior part, the second part, and the center part are joined together by one or more layers of a resin selected from the group consisting of low density polyethylene, linear low density polyethylene, medium density polyethylene, high density polyethylene, maleated polyethylene, anhydride grafted ethylene/1-butene copolymer, anhydride grafted ethylene/1-hexene copolymer, propylene ethylene copolymer, ethylene vinyl acetate copolymer, ethylene methyl acrylate copolymer, anhydride grafted ethylene/1-octene copolymer and combinations thereof. In another embodiment, the top second part is ethylene vinyl alcohol and bottom second part is polyvinyl alcohol. In yet another embodiment, the top second part is poly vinyl alcohol and bottom second part is ethylene vinyl alcohol. In still another embodiment, the top second part is ethylene vinyl alcohol and bottom second part is poly vinyl alcohol.

In an embodiment of the present disclosure, there is provided a packaging laminate as disclosed herein, wherein the laminate has an oxygen transmission rate (OTR) equal to or less than 0.05 cm³/m²/1 day/1 atm, at a temperature in a range of 22° C.-25° C. at a relative humidity of 0% RH, ASTM D 3985-05.

In an embodiment of the present disclosure, there is provided a packaging laminate as disclosed herein, wherein the laminate reduces the oxygen transmission rate (OTR) by 2-15 times of 0.1 to 0.5 cc/m²·day, ASTM D 3985-05.

In an embodiment of the present disclosure, there is provided a process of preparing the packaging laminate as disclosed herein, wherein the laminate is prepared by a process selected from blown film process, cast film process, and extrusion lamination and/or adhesive lamination of blown or cast films.

In an embodiment of the present disclosure, there is provided an article comprising the packaging laminate as disclosed herein.

In an embodiment of the present disclosure, there is provided an article as disclosed herein, wherein the article is selected from a lamitube, shoulder barrier liner, inner barrier liner of a tube, or a pouch.

In an embodiment of the present disclosure, there is provided an article as disclosed herein, wherein the article is a lamitube which possess high mechanical stability, shoulder bond strength and burst strength.

In an embodiment of the present disclosure, there is provided a use of the packaging laminate as disclosed herein.

Although the subject matter has been described in considerable detail with reference to certain embodiments thereof, other embodiments are possible. As such, the spirit and scope of the disclosure should not be limited to the description of the embodiments contained herein.

### EXAMPLES

The disclosure will now be illustrated with following examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

### Example 1

The process of preparing the packaging laminate disclosed herein, was prepared by lamination of individual blown films of an exterior part, a second part and a center part.

The exterior and center parts were individually obtained by blown film extrusion of alkylene polymer having density in a range of 0.833 g/cm³-0.99 g/cm³. In an example, the exterior part was obtained by blown film extrusion of alkylene polymer of high-density polyethylene optionally along with LD and/or LLDPE. In another example, the exterior part was obtained by blown film extrusion of alkylene polymer of medium density polyethylene optionally along with LD and/or LLDPE. In further example, the exterior part was obtained by blown film extrusion of a combination of alkylene polymer of medium density and high-density polyethylene optionally along with LD and/or LLDPE. Similarly, the center part was obtained by the blown film extrusion of one or more layers of alkylene polymer with medium and/or high-density polyethylene optionally along with LD and/or LLDPE. In examples 1, 2, 3, 4 and comparative example, the exterior and center parts are obtained by the blown film extrusion of alkylene polymer which is polyethylene. In one another example, the exterior and center parts are obtained by the extrusion of alkylene polymer which is polypropylene.

The exterior part comprises one or more parts, wherein each of the parts were obtained from multilayer blown film extrusion of at least one of alkylene polymer selected from high-density polyethylene (HDPE), medium-density polyethylene (MDPE), low-density polyethylene (LDPE), linear low-density polyethylene (LLDPE), polypropylene, or combinations thereof. The exterior part comprises upper part, middle part, and lower part, wherein each of the part comprised 10 to 90% by weight of HDPE and/or MDPE, remaining with LLDPE and/or LDPE.

Similarly, the center part comprises of one or more parts, wherein each of the parts were obtained from multilayer blown film extrusion of at least one of alkylene polymer selected from high-density polyethylene (HDPE), medium-density polyethylene (MDPE), low-density polyethylene (LDPE), linear low-density polyethylene (LLDPE), polypropylene or combinations thereof. The center part comprises top center part, inner center part, and bottom center part, wherein each of the part comprised 10 to 90% by weight of HDPE and/or MDPE, remaining with LLDPE and/or LDPE.

The second part was obtained by blown film extrusion of granular poly vinyl alcohol (PVOH) and/or ethylene vinyl alcohol (EVOH). The various examples of second part arrangements are given below. The barrier layers are sandwiched always by a tie layer. The tie resin was selected from the group consisting of maleated polyethylene, anhydride grafted ethylene/1-butene copolymer, anhydride grafted ethylene/1-hexene copolymer, propylene ethylene copolymer, ethylene vinyl acetate copolymer, ethylene methyl acrylate copolymer, anhydride grafted ethylene/1-octene copolymer and combinations thereof. The second part further comprises one alkylene polymer at the bottom and top surfaces.

In an example 1 the top second part was obtained by blown film extrusion of granular PVOH which was melt-processed to obtain a PVOH film of thickness 2 μm and bottom second part was obtained by blown film extrusion of ethylene vinyl alcohol to obtain EVOH film of thickness 10 μm.

In example 2, the top second part was obtained by blown film extrusion of granular poly vinyl alcohol which was melt-processed to obtain a PVOH film of thickness 3 μm and bottom second part was obtained by blown film extrusion of ethylene vinyl alcohol to obtain EVOH film of thickness 10 μm.

In further example 3, the top second part was obtained by blown film extrusion of granular poly vinyl alcohol which was melt-processed to obtain a PVOH film of thickness 3 μm and bottom second part was obtained by blown film extrusion of granular poly vinyl alcohol which was melt-processed to obtain a PVOH film of thickness 2 μm.

In an example 4, the top second part was obtained by blown film extrusion of ethylene vinyl alcohol to obtain EVOH film of thickness 3 μm and bottom second part was obtained by blown film extrusion of granular poly vinyl alcohol which was melt-processed to obtain a PVOH film of thickness 2 μm.

As a comparative example (CE), the top second part was obtained by blown film extrusion of granular poly vinyl alcohol which was melt-processed to obtain a PVOH film of thickness 5 μm.

Layered packaging laminate samples were obtained by the extrusion (or) adhesive lamination of the exterior, second parts and center parts as mentioned above. The Sample 1 (S-1) was obtained by the lamination of the exterior, center and the second parts according to example 1, with each of the parts adjoined with each other using a resin. Similarly, Samples 2, 3, 4 and comparative sample were obtained from adjoining the above-mentioned exterior part, center part and second parts according to examples 2, 3, 4 and CE, respectively, using a resin in between them as shown in Table 1.

The resin was selected from the group consisting of, low-density polyethylene, linear low-density polyethylene, medium-density polyethylene, high-density polyethylene and combinations thereof.

TABLE 1

| Sample | Arrangement of parts |
|---|---|
| S-1 | 20 μm PE/9 μm resin/2 μm PVOH/9 μm Tie/ |
| | 70 μm PE/9 μm Tie/10 μm EVOH/9 μm resin/85 μm PE |
| S-2 | 20 μm PE/9 μm resin/3 μm PVOH/9 μm Tie/ |
| | 70 μm PE/9 μm Tie/10 μm EVOH/9 μm resin/85 μm PE |
| S-3 | 20 μm PE/9 μm resin/3 μm PVOH/9 μm Tie/ |
| | 70 μm PE/9 μm Tie/2 μm PVOH/9 μm resin/85 μm PE |
| S-4 | 20 μm PE/9 μm resin/3 μm EVOH/9 μm Tie/ |
| | 70 μm PE/9 μm Tie/2 μm PVOH/9 μm resin/85 μm PE |
| Comparative | 100 μm PE/9 μm resin/5 μm PVOH/9 μm resin/ |
| Sample | 100 μm PE/PE/PE/PE |

### Example 2

The oxygen transmission rate for the Samples 1 to 4 were tested at a temperature in the range of 22° C.-25° C. at a relative humidity of 0% RH, by ASTM D 3985-05 and compared with that of the comparative sample, and the values are shown in Table 2 below.

TABLE 2

| Sample | OTR* (cc/m² · day)(23° C. & 0% RH) |
|---|---|
| Sample -1 | 0.0016 |
| Sample -2 | −0.017 |
| Sample -3 | 0.038 |
| Sample -4 | 0.045 |
| Comparative Sample | 0.150 |

*Machine Readings as it is, the Sensitivity is 0.05 cc/m²/day/atm.

The packaging laminate samples as disclosed herein, wherein the laminate reduces the oxygen transmission rate (OTR) by 2-15 times of 0.1 to 0.5 cc/m2·day/1 atm. The transmission rate was found the least for the Sample 2, wherein the second part of the barrier component was taken as 3 μm PVOH and 10 μm EVOH. The combination of the two barrier components hence contributed towards the barrier properties. Therefore, the layered material disclosed herein, wherein the barrier components were melt-processed followed by blown-extruded PVOH and extruded EVOH, provided an efficient packaging material.

### Example 3

### Preparation of a Lamitube

The sample 2 as disclosed above, was taken to be processed into a lamitube as an exemplification in the following example. A lamitube was prepared out of the Sample 2 by extrusion or adhesive lamination of the different layers arranged according to the order as explained above in Table 1. The individual sheets were then sliced into a sheet of width in the range of 63 to 320 mm. The sheets obtained from slicing, were then rolled to obtain the lamitube with a thickness in a range of 170 μm-400 μm and an ovality less than 7%. The parameters of the lamitube obtained is illustrated in Table 3.

TABLE 3

| Tube | Values |
|---|---|
| Diameter | 35 mm |
| Length | 170 mm |
| Ovality | <7% |

### Example 4

### Analysis of Lamitube Properties

The lamitube obtained by the process as explained above was then tested for burst strength by applying a particular pressure for a specific time period, shoulder bond strength by pulling apart by clamping at shoulder and sides of the tube, and mechanical stability by drop test.

### A. Analysis of Burst Strength

Burst strength refers to the ability of a lamitube to withstand a high pressure for a specified time period. The tube was held by the nozzle in an air-tight manner in a Burst Strength Tester. The pressure was set at 2 bar and held for 30 secs. The lamitube was found to withstand this condition without getting bursted for a time period of up to 30 seconds.

The burst strength test results showed that the prepared lamitubes had the ability to withstand internal pressure of about 2 bar without bursting. No cracks, or breakage was found after the experiment which concludes that the lamitube possessed high burst strength. Hence, the lamitubes obtained from sample 2 was found to pass the test of burst strength test.

### B. Analysis of Shoulder Bond Strength

Shoulder Bond Strength refers to the adhesion strength between the shoulder and the sleeve of the lamitube. When the lamitube was pulled from the sleeve end with shoulder in-between, if the shoulder and the sleeve of the lamitube do not separate at the adjoint instead the sleeve breaks, it indicates the tube has good shoulder bond strength.

The tube was cut diagonally through opposite sides with 15 mm strip and pull tested in a tensile machine/by hand to check the strength. The strips were found to be tearing without getting separated from the shoulder, which proved high strength of shoulder bond. Thus, the lamitubes obtained from sample 2 was found to pass the test of shoulder bond strength.

### C. Drop Test:

The lamitube was filled with a product and was dropped from a height of 1.5 meters to check whether it was tearing/cracking. After 3 drops, the tube showed no leaks, cracks, tears, or any failure were observed. Thus, the lamitubes obtained from Sample 2 was found to pass the test of drop test.

The observations for each of the analysis are collectively shown in Table 4.

TABLE 4

| | |
|---|---|
| Burst Strength | Withstood, 2 Bar for up to 30 |
| | secs; No failures observed. |
| Shoulder Bond Strength | Passed |
| Drop Test | Passed |

### ADVANTAGES OF THE PRESENT DISCLOSURE

The present disclosure provides a packaging laminate comprising a layer of melt processable polyvinyl alcohol in the barrier component which withstood 2 bar pressure for up to 30 seconds and passed both drop test and shoulder bond strength. The laminate of the present disclosure reduces the oxygen transmission rate (OTR) by 2-15 times of 0.1 to 0.5 cc/m²·day/1 atm. The process disclosed in the present disclosure provides a convenient method for the preparation of the obtained laminate from extrusion of a solid polyvinyl alcohol granules.

1. A packaging laminate comprising:
an exterior part of at least one alkylene polymer;
a second part comprising a top second part and a bottom second part having at least one barrier component; and
a center part of at least one alkylene polymer,
wherein:
the center part is disposed between the top second part and the bottom second part;
the second part is in contact with the exterior part on both sides;
the barrier component of at least one of the top second part and the bottom second part comprises a layer of melt processable polyvinyl alcohol; and
each of the layer of melt processable polyvinyl alcohol has a thickness in a range of 1 to 15 microns.

2. The packaging laminate as claimed in claim 1, wherein each of the layer of melt processable polyvinyl alcohol is obtained from extrusion of a solid polyvinyl alcohol granules.

3. The packaging laminate as claimed in claim 1, wherein the barrier component comprises one or more layers of ethylene vinyl alcohol, nylon, or combinations thereof.

4. The packaging laminate as claimed in claim 1, wherein the at least one alkylene polymer is a monolayer or a multilayer of an alkylene polymer having density in a range of 0.833 g/cm³ to 0.99 g/cm³.

5. The packaging laminate as claimed in claim 1, wherein the exterior part has thickness in a range of 3 μm to 200 μm.

6. The packaging laminate as claimed in claim 1, wherein the center part has thickness in a range of 1 μm to 250 μm.

7. The packaging laminate as claimed in claim 1, wherein the second part has thickness in a range of 2 μm to 150 μm.

8. The packaging laminate as claimed in claim 1, wherein the laminate has thickness in a range of 6 μm to 400 μm.

9. The packaging laminate as claimed in claim 1, wherein the exterior part, the second part, and the center part are joined together by one or more layers of a resin selected from a group consisting of a laminating resin, a tie resin, an adhesive resin, and a promoter resin.

10. The packaging laminate as claimed in claim 9, wherein the one or more layers of the resin has a thickness in a range of 2 μm to 70 μm.

11. The packaging laminate as claimed in claim 9, wherein the resin is selected from the group consisting of low-density polyethylene, linear low-density polyethylene, medium-density polyethylene, high-density polyethylene, maleated polyethylene, anhydride grafted ethylene/1-butene copolymer, anhydride grafted ethylene/1-hexene copolymer, propylene ethylene copolymer, ethylene vinyl acetate copolymer, ethylene methyl acrylate copolymer, anhydride grafted ethylene/1-octene copolymer or combinations thereof; the adhesive resin is polyurethane; and the promoter resin is polyethylene imine.

12. The packaging laminate as claimed claim 1, wherein the laminate has an oxygen transmission rate (OTR) equal to or less than 0.05 cm³/m²/1 day/1 atm, at a temperature in a range of 22° C. to 25° C. at a relative humidity of 0% RH.

13. The packaging laminate as claimed in claim 1, wherein the laminate reduces the oxygen transmission rate (OTR) by 2 to 15 times of 0.1 to 0.5 cc/m²·day/1 atm.

14. A process of preparing the packaging laminate as claimed in claim 1, wherein the laminate is prepared by a process selected from blown film process, cast film process, and extrusion lamination and/or adhesive lamination of blown or cast films.

15. An article comprising the packaging laminate as claimed in claim 1.

16. The article as claimed in claim 15, wherein the article is selected from a lamitube, shoulder barrier liner, inner barrier liner of a tube, or a pouch.

17. (canceled)
